(19) United States
(12) Patent Application Publication
(10) Pub. No.: US 2023/0087297 A1
(43) Pub. Date: Mar. 23, 2023

(54) MODULUS REDUCTION FOR CRYPTOGRAPHY

(71) Applicant: Intel Corporation, Santa Clara, CA (US)

(72) Inventors: Santosh Ghosh, Hillsboro, OR (US); Andrea Basso, London (GB)

(73) Assignee: Intel Corporation, Santa Clara, CA (US)

(21) Appl. No.: 17/478,624

(22) Filed: Sep. 17, 2021

(51) Int. Cl. H04L 9/32; H04L 9/30

(52) U.S. Cl. CPC H04L 9/3252; H04L 9/3093; H04L 2209/12

(57) ABSTRACT

Modulus reduction for cryptography is described. An example of an apparatus includes multiplier circuitry to perform integer multiplication; and modulus reduction circuitry to perform modulus reduction based on a prime modulus, wherein the modulus reduction circuitry is to receive a product value, the product value resulting from multiplying a first n-bit value by a second n-bit value to generate the product value and perform modulus reduction to reduce the product value to a result within the prime modulus; and wherein the modulus reduction circuitry is based on shift and add operations.

### TECHNICAL FIELD

Embodiments described herein generally relate to the field of electronic devices and, more particularly, modulus reduction for cryptography.

### BACKGROUND

In modern cryptographic operations, key encapsulation mechanisms (KEMs) are encryption techniques to secure symmetric cryptographic key material for transmission. Such mechanisms utilize asymmetric (public key) algorithms in which difficult mathematical problems are implemented in calculation to protect against attack. Such methods provide strong protection against conventional computation because, even if data from calculations can be determined, the resulting mathematical problem cannot be practically solved.

However, quantum computing is expected to enable attackers to solve problems that were previously impractical to attempt, including the solving of cryptographic mathematics in KEMs. Attacks may utilize side channels to obtain signals from cryptographic computation, and apply quantum computing to determine secret values. As a result, any existing cryptographic methods may potentially be broken.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 is an illustration of an operation for key signature generation, according to some embodiments;

FIG. 2 is an illustration of a reference implementation of modulus reduction in a cryptographic operation;

FIG. 3 is an illustration of an implementation of modulus reduction in a cryptographic operation including shift-add based reduction, according to some embodiments;

FIG. 4 illustrates a first example implementation of modulus reduction in a cryptographic operation including shift-add based reduction, according to some embodiments;

FIG. 5 illustrates a second example implementation of modulus reduction in a cryptographic operation including shift-add based reduction, according to some embodiments;

FIGS. 6A and 6B illustrates a third example implementation of modulus reduction in a cryptographic operation including shift-add based reduction, according to some embodiments;

FIG. 7 is an illustration of a process for a key operation including modulus reduction, according to some embodiments; and

FIG. 8 illustrates an embodiment of an exemplary computing architecture for operations including modulus multiplication with modulus reduction, according to some embodiments.

### DETAILED DESCRIPTION

Embodiments described herein are directed to low latency modulus reduction for cryptography.

Public key cryptography, also referred to as asymmetric cryptography, is in general a cryptographic system that uses pairs of keys in encryption, the pairs including public keys that may be publicly known and private keys that are securely maintained and only known by the key owner. The key pairs are generated utilizing cryptographic algorithms that are based on difficult mathematical problems.

It is expected that classical public-key cryptography, such as Elliptic Curve Cryptography (ECC), Elliptic Curve Digital Signature Algorithm (ECDSA), Diffie-Hellman (DH), Rivest Shamir Adleman (RSA), Digital Signature Algorithm (DSA), will be broken by quantum computers, referring to computers that exploit properties of quantum states to perform computation. Further, adversaries may be currently mining data from cryptographic operations to implement when sufficient quantum computing technology is available.

For this reason, Post-Quantum Cryptography Standardization is a program and competition by the National Institute of Standards and Technology (NIST) to update their standards to include post-quantum cryptography. However, there is a pressing need to develop post quantum secure KEM solutions as soon as possible.

In lattice KEMs for cryptographic operations, one secret polynomial is multiplied with another public polynomial. The multiplication consists of sequentially multiplying each coefficient of the secret polynomial with a respective element of the public polynomial. The polynomials may be degree-256 polynomials in a post quantum implementation. Multiplications between two such polynomials is the main compute intensive operation for key-generation, encapsulation, and decapsulation. The mathematical operation utilizes modular arithmetic, referring to a system of arithmetic for integers where numbers wrap around when reaching a certain value, called the modulus. In such operation, modulus reduction is generally required to maintain the intermediate multiplication results within the defined size (wherein the defined size may be the size of the Prime field, 26-bit, 23-bit, 13-bit, or other applicable size).

In KEM operations, implementations may utilize Montgomery modulus reduction technique in calculation of modular arithmetic, where Montgomery modular multiplication (also referred to as Montgomery multiplication) is a method for performing fast modular multiplication. Montgomery reduction is a technique to increase the speed of back-to-back modular multiplications by transforming the numbers into a special representation of numbers referred to as Montgomery form. The algorithm uses the Montgomery forms of a and b to efficiently compute the Montgomery form of ab mod N. The efficiency comes from avoiding expensive division operations. Classical modular multiplication reduces the double-width product ab using division by N and keeping only the remainder. This division requires quotient digit estimation and correction. The Montgomery form depends on a constant R>N that is coprime to N, with the only division necessary in Montgomery multiplication being division by R.

Further, operations may utilize Barret reduction. In Barrett reduction, for a given n, a factor is precomputed using division, with thereafter the computations of ab mod n utilizing multiplications, subtractions, and shifts.

However, the existing techniques for Montgomery and Barrett reductions are latency and area intensive for calculation, with existing techniques including Division operations. Improved efficiency in modulus reduction is extremely important in providing lattice based KEM and digital signature technology for post quantum operation, and thus the elimination of Division operations can greatly improve the overall performance of security operations.

In some embodiments, an apparatus, system, or process is to exploit prime modulus structures to perform efficient reductions of large multiplication results to less than the modulus value. In an embodiment, processes are based on Shift and Add operations without utilizing Division operations, in contrast with the existing techniques requiring Division operations, thereby allowing for significant improvement in processing efficiency.

Further, an embodiment only requires O(n) area costs, compared to O(n2) for the existing techniques. In a particular example of a prime modulus q=2²³−2¹³+1, a particular embodiment will utilize four 13-bit and five 23-bit integer additions vs existing approach costs two 23-bit multiplications+two/three 23-bit additions. Each multiplication costs approximately 22 additions on 23-bit numbers. As a result an embodiment may achieve a reduction of approximately 6× in computation costs in comparison with existing techniques.

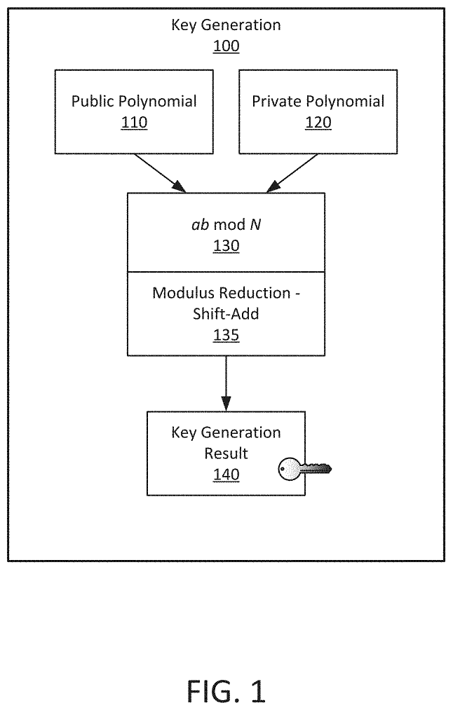

FIG. 1 is an illustration of an operation for key signature generation, according to some embodiments. As illustrated, in a mechanism or operation for key generation 100, such as in a lattice-based KEM operation for post quantum computing operation, processing includes multiplication of two polynomials, the polynomials being a first public polynomial 110 and a second private polynomial 120, to generate a result 140. The operation applies a modulus multiplication operation 130 of ab mod N performed by a multiplier circuitry or process, N being a prime modulus.

In some embodiments, the modulus multiplication operation 130 includes a low latency modulus reduction 135 to improve the efficiency of the calculation. In some embodiments, the modulus reduction 135 is a shift-add based reduction that is structured based upon the specific structure of the relevant prime modulus for the key generation mechanism or operation 100, and includes dividing the product value from the multiplication into multiple parts and adding the parts together with appropriate left or right shifts.

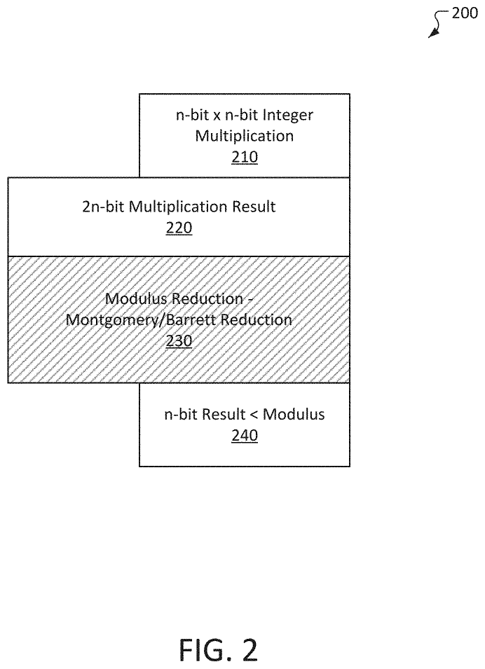

FIG. 2 is an illustration of a reference implementation of modulus reduction in a cryptographic operation. In an implementation of a mechanism or process 200, an n-bit by n-bit integer multiplication 210 is performed by a multiplier circuitry or process. The multiplication may, for example, relate to multiplication in KEM technology.

In the reference technology, the n-bit by n-bit integer multiplication 210 results in a 2n-bit multiplication result 220. A modulus reduction operation 230 is then applied, wherein the modulus reduction may include Montgomery or Barrett reduction. The result of the operation following the modulus reduction 230 is then n-bit result that is less than the modulus value 240.

However, the Division operation basis of the Montgomery or Barrett reduction reduces the performance of the modulus reduction 230, which limits the application of the operation in, for example, post quantum operations utilizing large polynomial multiplication.

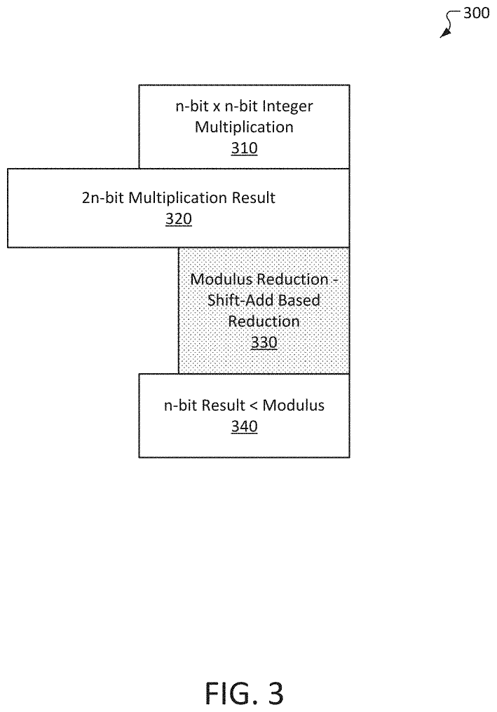

In some embodiments, the modulus reduction 230 is replaced with a Shift-Add based modulus reduction, such as illustrated in FIG. 3.

FIG. 3 is an illustration of an implementation of modulus reduction in a cryptographic operation including shift-add based reduction, according to some embodiments. In some embodiments, a mechanism or process implementation 300 includes performance of an n-bit by n-bit integer multiplication by a multiplier circuitry or process 310, such as in multiplication of a first degree-256 polynomial by a second degree-256 polynomial in lattice-based KEM technology in post quantum operation.

In the illustrated technology, the n-bit by n-bit integer multiplication 310, the multiplication applying a prime modus q and resulting in a 2n-bit multiplication result 320. In some embodiments, a modulus reduction operation 330 is then applied by a modulus reduction circuitry or process, wherein the modulus reduction operation includes a Shift-Add based modulus reduction.

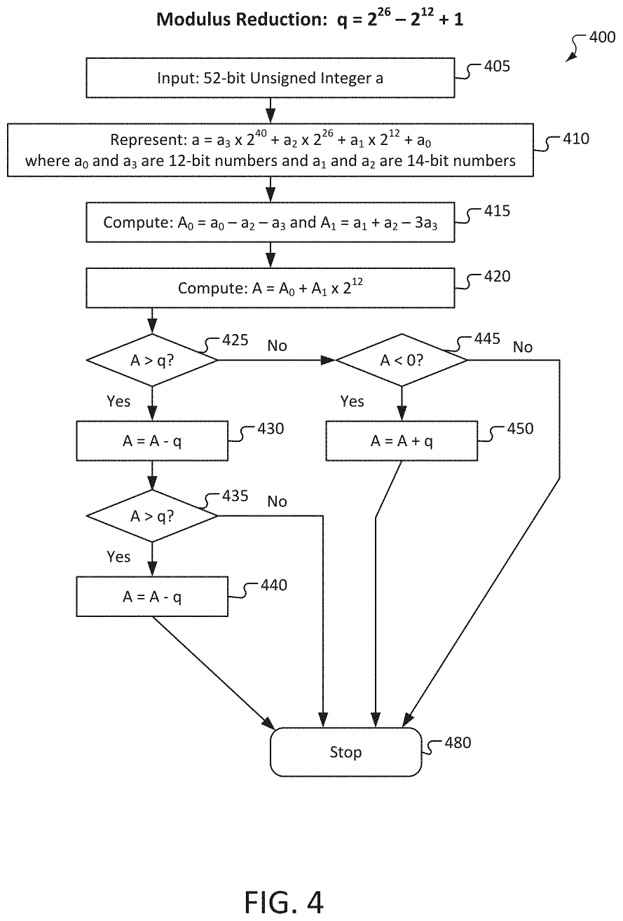

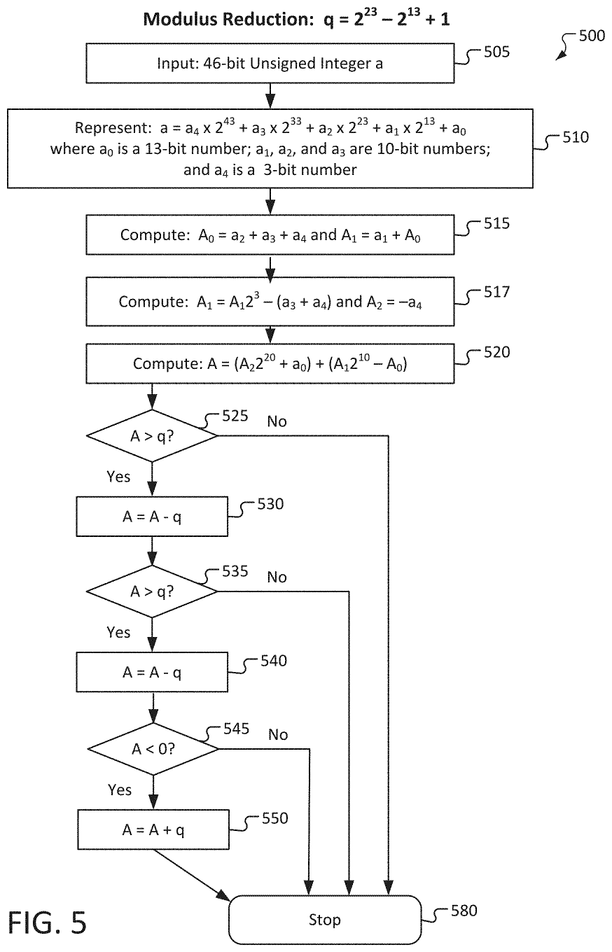

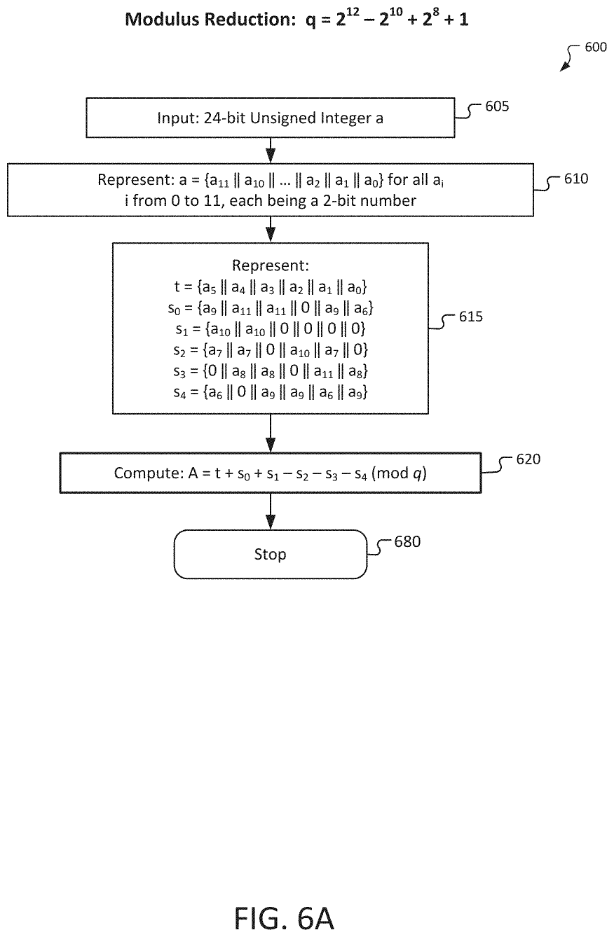

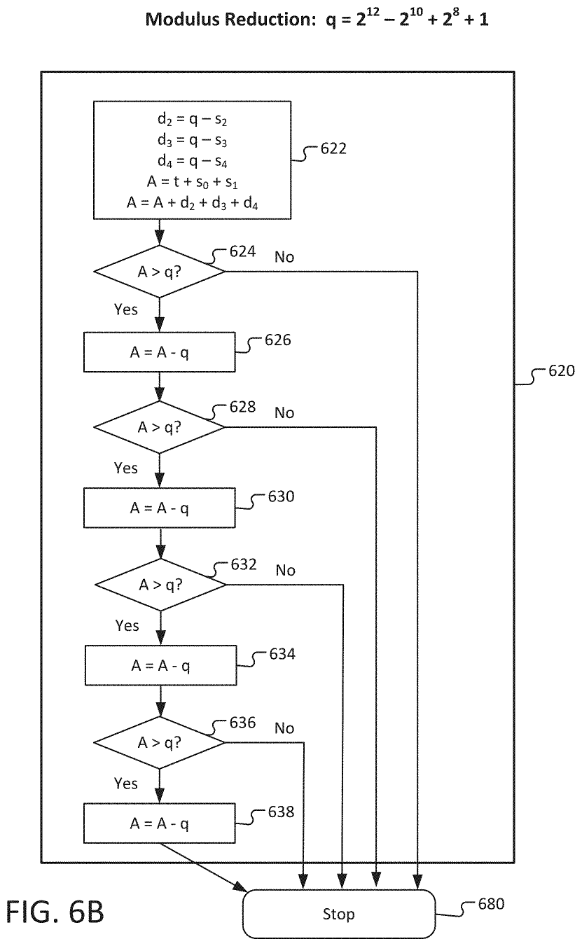

In some embodiments, the shift-add based modulus reduction is structured based upon the specific structure of the prime modulus, wherein the number involved is divided into multiple parts and added together with appropriate left or right shifts. The modulus reduction operation may include, but is not limited to, the modulus reduction for q=2²⁶−2¹²+1 illustrated in FIG. 4, the modulus reduction for q=2²³−2¹³+1 illustrated in FIG. 5, or the modulus reduction for q=2¹²−2¹⁰+2⁸+1 illustrated in FIGS. 6A and 6B.

The result of the operation following the modulus reduction 330 is then an n-bit result that is less than the modulus value 340.

FIG. 4 illustrates a first example implementation of modulus reduction in a cryptographic operation including shift-add based reduction, according to some embodiments. In some embodiments, a modulus reduction 400 for a modulus q=2²⁶−2¹²+1 includes receiving an input of a 52-bit unsigned integer a 405. Based on the prime modulus, a representation of the input value 410 is expressed as:

a=a₃×2⁴⁰+a₂×2²⁶+a₁×2¹²+a₀

where a₀ and a₃ are 12-bit numbers and a₁ and a₂ are 14-bit numbers

Computations are then made for intermediate values A0 and A1, (415) and the product value A (420):

A₀=a₀−a₂−a₃

A₁=a₁+a₂−3a₃

A=A₀+A₁×2¹²

In some embodiments, based on the modulus reduction operation that is implemented, the product value A may then be converted to a modulus reduced value by:

If A is greater than q (425), then A equals A minus q (430). If A remains greater than q (435), then A equals A minus q (440), and stop modulus reduction (480). If A does not remain greater than q (435), then stop modulus reduction (480).

If A is not greater than q (425), then determine if A is less than zero (445). If A is less than zero (445), then A equals A plus q (450) and stop modulus reduction (480). If A is not than zero (445), then stop modulus reduction (480).

FIG. 5 illustrates a second example implementation of modulus reduction in a cryptographic operation including shift-add based reduction, according to some embodiments. In some embodiments, a modulus reduction 500 for a modulus q=2²³−2¹³+1 includes receiving an input of a 46-bit unsigned integer a 505. Based on the prime modulus, a representation of the input value is expressed as:

a=a₄×2⁴³+a₃×2³³+a₂×2²³+a₁×2¹³+a₀

where a₀ is a 13-bit number; a₁, a₂, and a₃ are 10-bit numbers; a₄ is a 3-bit number.

Computations are then made for intermediate values A0 and A1 (515 and 517), and the product value A (520):

A₀=a₂+a₃+a₄

A₁=a₁+A₀

A₁=A₁2³−(a₃+a₄)

A₂=−a₄

A=(A₂2²⁰+a₀)+(A₁2¹⁰−A₀).

The computation, A₂2²⁰+a₀ can be computed as A₂2²⁰+a₀={A₂∥7′b0∥a₀} without actual addition operation because a₀ is only 13 bits long. In expression {A₂∥7′b0∥a₀}, x∥y represents concatenation of bit string x followed by bit string y.

In some embodiments, based on the modulus reduction operation that is implemented, the product value A may be converted to a modulus reduced value by:

If A is greater than q (525), then A equals A minus q (530). If A is not greater than q, stop modulus reduction (580).

If A remains greater than q (535), then A equals A minus q (540). If A is not greater than q, stop modulus reduction (580).

If A is less than 0 (545), then A equals A plus q (550) and stop modulus reduction (580).

FIGS. 6A and 6B illustrates a third example implementation of modulus reduction in a cryptographic operation including shift-add based reduction, according to some embodiments. As illustrated in FIG. 6A, in some embodiments a modulus reduction 600 for a modulus q=2¹²−2¹⁰+2⁸+1 includes receiving an input of a 24-bit unsigned integer a 605. Based on the prime modulus, a representation of the input value 610 is expressed as 12 2-bit numbers designated as aᵢ from 1=0 to 11:

a=a={a₁₁|a₁₀| . . . |a₂|a₁|a₀}

where each aᵢ is a 2-bit number

Further intermediate values are then represented 615 by the concatenated values using the aᵢ values:

t={a₅|a₄|a₃|a₂|a₁|a₀}

s₀={a₉|a₁₁|a₁₁|0|a₉|a₆}

s₁={a₁₀|a₁₀|0|0|0|0}

s₂={a₇|a₇|0|a₁₀|a₇|0}

s₃={0|a₈|a₈|0|a₁₁|a₈}

s₄{a₆|0|a₉|a₉|a₆|a₉}

A product value A is then computed 620 as:

A=t+s₀+s₁−s₂−s₃−s₄(mod q)

Following the computation of A 620, the modulus reduction is stopped 680.

FIG. 6B illustrates details of the computation of A 620, wherein computations are then made for intermediate values and the product value A (622) as follows:

d₂=q−s₂

d₃=q−s₃

d₄=q−s₄

A=t+s₀+s₁

A=A+d₂+d₃+d₄

In some embodiments, based on the modulus reduction operation that is implemented, the product value A may be converted to a modulus reduced value by:

If A is greater than q (624), then A equals A minus q (626). If A is not greater than q, stop modulus reduction (680).

If A remains greater than q (628), then A equals A minus q (630). If A is not greater than q, stop modulus reduction (680).

If A remains greater than q (632), then A equals A minus q (634). If A is not greater than q, stop modulus reduction (680).

If A remains greater than q (636), then A equals A minus q (638), and stop modulus reduction (680). If A is not greater than q, stop modulus reduction (680).

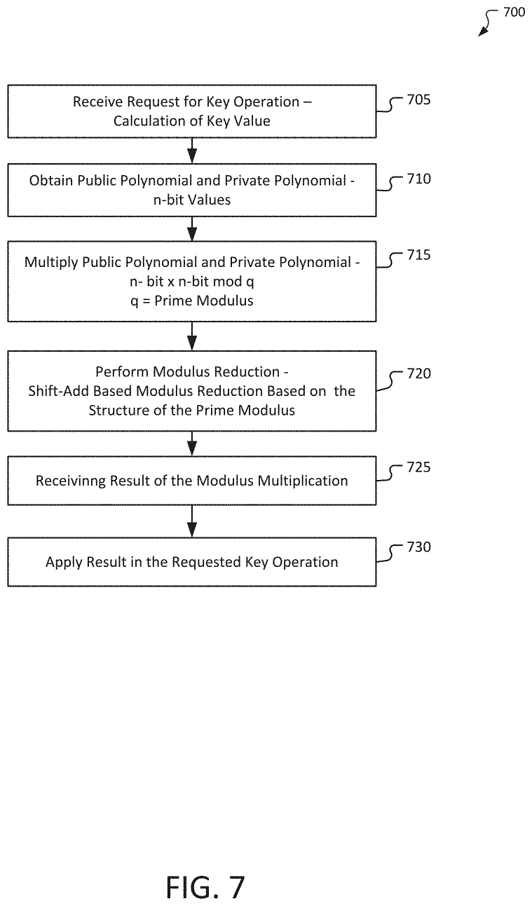

FIG. 7 is an illustration of a process for a key operation including modulus reduction, according to some embodiments. In a process 700, a request is received for a key operation, such as a post quantum KEM operation, involving calculation of a key value 705. The key operation includes obtaining public and private values, such as a public polynomial and a private polynomial 710, include n-bit value for multiplication. The process continues with multiplication of the public polynomial and the private polynomial 715, the multiplication being an n-bit by n-bit modulus multiplication operation for each set of coefficients, with q equaling a certain prime modulus.

In some embodiments, the process 700 continues with performing a modulus reduction for each multiplication of coefficients 720, wherein the modulus reduction is a Shift-Add based modulus reduction that is based on the structure of the prime modulus. The modulus reduction operation may include, but is not limited to, the modulus reduction for q=2²⁶−2¹²+1 illustrated in FIG. 4, the modulus reduction for q=2²³−2¹³+1 illustrated in FIG. 5, or the modulus reduction for q=2¹²−2¹⁰+2⁸+1 illustrated in FIGS. 6A and 6B.

In some embodiments, the operation then proceeds with receiving the result of the modulus multiplication 725, and applying the result in the request key operation 730.

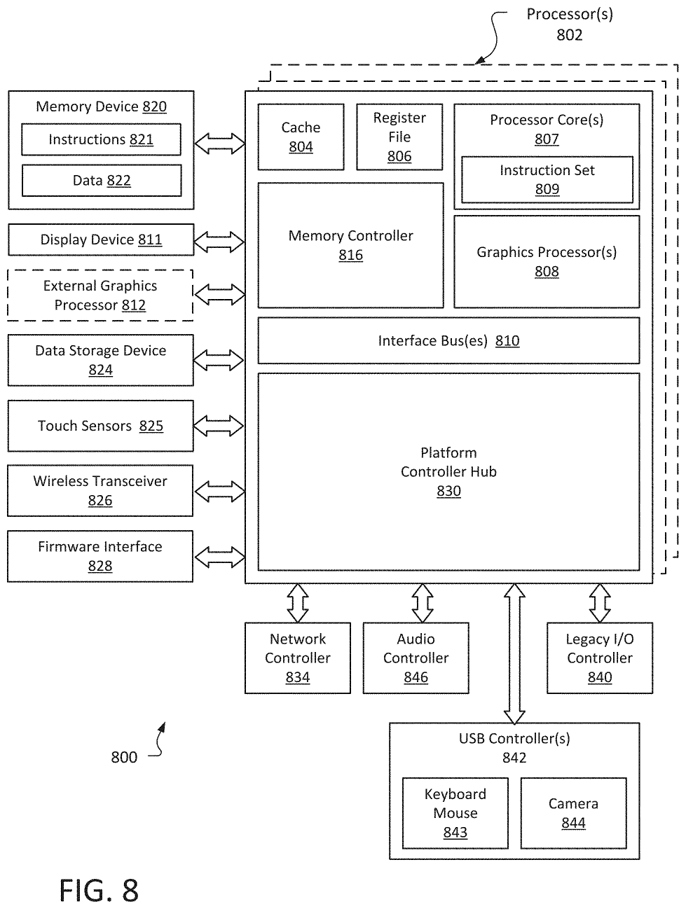

FIG. 8 illustrates an embodiment of an exemplary computing architecture for operations including modulus multiplication with modulus reduction, according to some embodiments. In various embodiments as described above, a computing architecture 800 may comprise or be implemented as part of an electronic device. In some embodiments, the computing architecture 800 may be representative, for example, of a computer system that implements one or more components of the operating environments described above, including multiplier circuitry to perform integer multiplication, and modulus reduction circuitry to perform modulus reduction based on a prime modulus. The computing architecture 800 may be utilized to provide modulus multiplication with modulus reduction, such as described in FIGS. 1-7.

As used in this application, the terms “system” and “component” and “module” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive or solid state drive (SSD), multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the unidirectional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 includes one or more processors 802 and one or more graphics processors 808, and may be a single processor desktop system, a multiprocessor workstation system, or a server system having a large number of processors 802 or processor cores 807. In one embodiment, the system 800 is a processing platform incorporated within a system-on-a-chip (SoC or SOC) integrated circuit for use in mobile, handheld, or embedded devices.

An embodiment of system 800 can include, or be incorporated within, a server-based gaming platform, a game console, including a game and media console, a mobile gaming console, a handheld game console, or an online game console. In some embodiments system 800 is a mobile phone, smart phone, tablet computing device or mobile Internet device. Data processing system 800 can also include, couple with, or be integrated within a wearable device, such as a smart watch wearable device, smart eyewear device, augmented reality device, or virtual reality device. In some embodiments, data processing system 800 is a television or set top box device having one or more processors 802 and a graphical interface generated by one or more graphics processors 808.

In some embodiments, the one or more processors 802 each include one or more processor cores 807 to process instructions which, when executed, perform operations for system and user software. In some embodiments, each of the one or more processor cores 807 is configured to process a specific instruction set 809. In some embodiments, instruction set 809 may facilitate Complex Instruction Set Computing (CISC), Reduced Instruction Set Computing (RISC), or computing via a Very Long Instruction Word (VLIW). Multiple processor cores 807 may each process a different instruction set 809, which may include instructions to facilitate the emulation of other instruction sets. Processor core 807 may also include other processing devices, such a Digital Signal Processor (DSP).

In some embodiments, the processor 802 includes cache memory 804. Depending on the architecture, the processor 802 can have a single internal cache or multiple levels of internal cache. In some embodiments, the cache memory 804 is shared among various components of the processor 802. In some embodiments, the processor 802 also uses an external cache (e.g., a Level-3 (L3) cache or Last Level Cache (LLC)) (not shown), which may be shared among processor cores 807 using known cache coherency techniques. A register file 806 is additionally included in processor 802 which may include different types of registers for storing different types of data (e.g., integer registers, floating point registers, status registers, and an instruction pointer register). Some registers may be general-purpose registers, while other registers may be specific to the design of the processor 802.

In some embodiments, one or more processor(s) 802 are coupled with one or more interface bus(es) 810 to transmit communication signals such as address, data, or control signals between processor 802 and other components in the system. The interface bus 810, in one embodiment, can be a processor bus, such as a version of the Direct Media Interface (DMI) bus. However, processor buses are not limited to the DMI bus, and may include one or more Peripheral Component Interconnect buses (e.g., PCI, PCI Express), memory buses, or other types of interface buses. In one embodiment the processor(s) 802 include an integrated memory controller 816 and a platform controller hub 830. The memory controller 816 facilitates communication between a memory device and other components of the system 800, while the platform controller hub (PCH) 830 provides connections to I/O devices via a local I/O bus.

Memory device 820 can be a dynamic random-access memory (DRAM) device, a static random-access memory (SRAM) device, non-volatile memory device such as flash memory device or phase-change memory device, or some other memory device having suitable performance to serve as process memory. Memory device 820 may further include non-volatile memory elements for storage of firmware. In one embodiment the memory device 820 can operate as system memory for the system 800, to store data 822 and instructions 821 for use when the one or more processors 802 execute an application or process. Memory controller hub 816 also couples with an optional external graphics processor 812, which may communicate with the one or more graphics processors 808 in processors 802 to perform graphics and media operations. In some embodiments a display device 811 can connect to the processor(s) 802. The display device 811 can be one or more of an internal display device, as in a mobile electronic device or a laptop device, or an external display device attached via a display interface (e.g., DisplayPort, etc.). In one embodiment the display device 811 can be a head mounted display (HMD) such as a stereoscopic display device for use in virtual reality (VR) applications or augmented reality (AR) applications.

In some embodiments the platform controller hub 830 enables peripherals to connect to memory device 820 and processor 802 via a high-speed I/O bus. The I/O peripherals include, but are not limited to, an audio controller 846, a network controller 834, a firmware interface 828, a wireless transceiver 826, touch sensors 825, a data storage device 824 (e.g., hard disk drive, flash memory, etc.). The data storage device 824 can connect via a storage interface (e.g., SATA) or via a peripheral bus, such as a Peripheral Component Interconnect bus (e.g., PCI, PCI Express). The touch sensors 825 can include touch screen sensors, pressure sensors, or fingerprint sensors. The wireless transceiver 826 can be a Wi-Fi transceiver, a Bluetooth transceiver, or a mobile network transceiver such as a 3G, 4G, Long Term Evolution (LTE), or 5G transceiver. The firmware interface 828 enables communication with system firmware, and can be, for example, a unified extensible firmware interface (UEFI). The network controller 834 can enable a network connection to a wired network. In some embodiments, a high-performance network controller (not shown) couples with the interface bus 810. The audio controller 846, in one embodiment, is a multi-channel high definition audio controller. In one embodiment the system 800 includes an optional legacy I/O controller 840 for coupling legacy (e.g., Personal System 2 (PS/2)) devices to the system. The platform controller hub 830 can also connect to one or more Universal Serial Bus (USB) controllers 842 connect input devices, such as keyboard and mouse 843 combinations, a camera 844, or other USB input devices.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

The following Examples pertain to certain embodiments:

In Example 1, an apparatus includes multiplier circuitry to perform integer multiplication; and modulus reduction circuitry to perform modulus reduction based on a prime modulus; wherein the modulus reduction circuitry is to receive a product value from the multiplier circuitry, the product value resulting from multiplying a first n-bit value by a second n-bit value to generate the product value; and perform modulus reduction to reduce the product value to a result within the prime modulus, wherein the modulus reduction circuitry is based on shift and add operations.

In Example 2, the modulus reduction circuitry does not perform any division operations.

In Example 3, the modulus reduction circuitry is implemented for a structure of the prime modulus.

In Example 4, the modulus reduction circuitry includes dividing the product value into a plurality of parts and adding the parts together utilizing left or right shifts.

In Example 5, the modulus reduction circuitry includes generating a plurality of intermediate values based on the parts of the product value.

In Example 6, the first n-bit value is a coefficient of a first polynomial and the second n-bit value is a coefficient of a second polynomial.

In Example 7, the first polynomial is a public polynomial and the second polynomial is a private polynomial for a lattice-based key encapsulation mechanism (KEM) and digital signature algorithm (DSA).

In Example 8, one or more non-transitory computer-readable storage mediums having stored thereon executable computer program instructions that, when executed by one or more processors, cause the one or more processors to perform operations comprising receiving a first n-bit value and a second n-bit value for integer multiplication with a prime modulus; multiplying the first n-bit value by the second n-bit value to generate a product value; and performing a modulus reduction to reduce the product value to a result within the prime modulus, wherein the modulus reduction is based on shift and add operations.

In Example 9, the performance of the modulus reduction does not include any division operations.

In Example 10, the modulus reduction is implemented for a structure of the prime modulus.

In Example 11, performance of the modulus reduction includes dividing the product value into a plurality of parts and adding the parts together utilizing left or right shifts.

In Example 12, performance of the modulus reduction includes generating a plurality of intermediate values based on the parts of the product value.

In Example 13, the first n-bit value is a coefficient of a first polynomial and the second n-bit value is a coefficient of a second polynomial.

In Example 14, the first polynomial is a public polynomial and the second polynomial is a private polynomial for a lattice-based key encapsulation mechanism (KEM) and digital signature algorithm (DSA).

In Example 15, a method includes receiving a first n-bit value and a second n-bit value for integer multiplication with a prime modulus; multiplying the first n-bit value by the second n-bit value to generate a product value; and performing a modulus reduction to reduce the product value to a result within the prime modulus, the modulus reduction being implemented for a structure of the prime modulus, wherein the modulus reduction is based on shift and add operations.

In Example 16, the performance of the modulus reduction does not include any division operations.

In Example 17, performance of the modulus reduction includes dividing the product value into a plurality of parts and adding the parts together utilizing left or right shifts.

In Example 18, performance of the modulus reduction includes generating a plurality of intermediate values based on the parts of the product value.

In Example 19, the first n-bit value is a coefficient of a first polynomial and the second n-bit value is a coefficient of a second polynomial.

In Example 20, the first polynomial is a public polynomial and the second polynomial is a private polynomial for a lattice-based key encapsulation mechanism (KEM) and digital signature algorithm (DSA).

In Example 21, a system includes one or more processors to process data, including integer multiplication; and a memory to store data, wherein the one or more processors are to perform integer multiplication with a prime modulus, the integer multiplication including: multiplying a first n-bit value by a second n-bit value to generate a product value; and performing modulus reduction to reduce the product value to a result within the prime modulus, wherein the modulus reduction is based on shift and add operations without division operations.

In Example 22, the modulus reduction is implemented for a structure of the prime modulus.

In Example 23, performance of the modulus reduction includes dividing the product value into a plurality of parts and adding the parts together utilizing left or right shifts.

In Example 24, performance of the modulus reduction includes generating a plurality of intermediate values based on the parts of the product value.

In Example 25, the first n-bit value is a coefficient of a first polynomial and the second n-bit value is a coefficient of a second polynomial.

In Example 26, the first polynomial is a public polynomial and the second polynomial is a private polynomial for a lattice-based key encapsulation mechanism (KEM) and digital signature algorithm (DSA).

In Example 27, an apparatus includes means for receiving a first n-bit value and a second n-bit value for integer multiplication with a prime modulus; means for multiplying the first n-bit value by the second n-bit value to generate a product value; and means for performing a modulus reduction to reduce the product value to a result within the prime modulus, wherein the modulus reduction is based on shift and add operations.

In Example 28, the means for performing the modulus reduction does not include any division operations.

In Example 29, the modulus reduction is implemented for a structure of the prime modulus.

In Example 30, the means for performing the modulus reduction includes means for dividing the product value into a plurality of parts and adding the parts together utilizing left or right shifts.

In Example 31, the means for performing the modulus reduction includes means for generating a plurality of intermediate values based on the parts of the product value.

In Example 32, the first n-bit value is a coefficient of a first polynomial and the second n-bit value is a coefficient of a second polynomial.

In Example 33, the first polynomial is a public polynomial and the second polynomial is a private polynomial for a lattice-based key encapsulation mechanism (KEM) and digital signature algorithm (DSA).

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

1. An apparatus comprising:
multiplier circuitry to perform integer multiplication; and
modulus reduction circuitry to perform modulus reduction based on a first prime modulus, the modulus reduction circuitry including circuitry that is implemented based on a structure of the first prime modulus;
wherein the modulus reduction circuitry is to:
receive a product value from the multiplier circuitry, the product value resulting from multiplying a first n-bit value by a second n-bit value to generate the product value, and
perform modulus reduction to reduce the product value to a result within the first prime modulus;
wherein the modulus reduction circuitry is based on shift and add operations in the performance of the modulus reduction for the product value.

2. The apparatus of claim 1, wherein the modulus reduction circuitry does not perform any division operations.

3. (canceled)

4. The apparatus of claim 1, wherein the modulus reduction circuitry includes dividing the product value into a plurality of parts and adding the parts together utilizing left or right shifts.

5. The apparatus of claim 4, wherein the modulus reduction circuitry includes generating a plurality of intermediate values based on the plurality of parts of the product value.

6. The apparatus of claim 1, wherein the first n-bit value is a coefficient of a first polynomial and the second n-bit value is a coefficient of a second polynomial.

7. The apparatus of claim 6, wherein the first polynomial is a public polynomial and the second polynomial is a private polynomial for a lattice-based key encapsulation mechanism (KEM) and digital signature algorithm (DSA).

8. One or more non-transitory computer-readable storage mediums having stored thereon executable computer program instructions that, when executed by one or more processors, cause the one or more processors to perform operations comprising:
receiving a first n-bit value and a second n-bit value for integer multiplication with a first prime modulus;
multiplying the first n-bit value by the second n-bit value to generate a product value; and
performing a modulus reduction to reduce the product value to a result within the first prime modulus utilizing a modulus reduction circuitry, the modulus reduction circuitry including circuitry that is implemented based on a structure of the first prime modulus;
wherein the modulus reduction is based on shift and add operations in the performance of the modulus reduction for the product value.

9. The storage mediums of claim 8, wherein the performance of the modulus reduction does not include any division operations.

10. (canceled)

11. The storage mediums of claim 8, wherein performance of the modulus reduction includes dividing the product value into a plurality of parts and adding the parts together utilizing left or right shifts.

12. The storage mediums of claim 11, wherein performance of the modulus reduction includes generating a plurality of intermediate values based on the plurality of parts of the product value.

13. The storage mediums of claim 8, wherein the first n-bit value is a coefficient of a first polynomial and the second n-bit value is a coefficient of a second polynomial.

14. The storage mediums of claim 13, wherein the first polynomial is a public polynomial and the second polynomial is a private polynomial for a lattice-based key encapsulation mechanism (KEM) and digital signature algorithm (DSA).

15. A method comprising:
receiving a first n-bit value and a second n-bit value for integer multiplication with a first prime modulus;
multiplying the first n-bit value by the second n-bit value to generate a product value; and
performing a modulus reduction to reduce the product value to a result within the first prime modulus utilizing a modulus reduction circuitry, the modulus reduction circuitry including circuitry that is implemented based on a structure of the first prime modulus;
wherein the modulus reduction is based on shift and add operations in the performance of the modulus reduction for the product value.

16. The method of claim 15, wherein the performance of the modulus reduction does not include any division operations.

17. The method of claim 15, wherein performance of the modulus reduction includes dividing the product value into a plurality of parts and adding the parts together utilizing left or right shifts.

18. The method of claim 17, wherein performance of the modulus reduction includes generating a plurality of intermediate values based on the plurality of parts of the product value.

19. The method of claim 15 wherein the first n-bit value is a coefficient of a first polynomial and the second n-bit value is a coefficient of a second polynomial.

20. The method of claim 19, wherein the first polynomial is a public polynomial and the second polynomial is a private polynomial for a lattice-based key encapsulation mechanism (KEM) and digital signature algorithm (DSA).

21. The apparatus of claim 1, wherein the modulus reduction circuitry modulus reduction circuitry includes circuitry that is implemented based on a structure of one or more of the following values for prime modulus q:
q=2²⁶−2¹²+1;
q=2²³−2¹³+1; or
q=2¹²−2¹⁰+2⁸+1.
